(19) United States
(12) Patent Application Publication
(10) Pub. No.: US 2003/0141482 A1
(43) Pub. Date: Jul. 31, 2003

(54) Hydraulic fluids having improved corrosion protection for non-ferrous metals

(76) Inventors: Bernd Wenderoth, Birkenau (DE); Michael Roida, Weingarten (DE); Knut Oppenlander, Ludwigshafen (DE); Ralf Strauss, Ludwigshafen (DE)

Correspondence Address: KEIL & WEINKAUF, 1350 CONNECTICUT AVENUE, N.W., WASHINGTON, DC, 20036, US

(21) Appl. No.: 10/296,055

(22) PCT Filed: May 16, 2001
(86) PCT No.: PCT/EP01/05550

(30) Foreign Application Priority Data
May 25, 2000 (DE) 100 26 010.1

(51) Int. Cl. C09K 5/00

(52) U.S. Cl. 252/71

(57) ABSTRACT

Hydraulic fluids, in particular brake fluids for motor vehicles, contain from 0.005 to 0.5% by weight of one or more heterocyclic compounds I

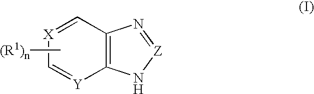

where

(i) X is N, Y is CR and Z is N or

(ii) X is N, Y is N and Z is N or CR or

(iii) X is CR, Y is N and Z is N,

R being hydrogen, halogen or an organic radical R¹ of 1 to 30 carbon atoms and n being 0, 1 or 2.

The present invention relates to hydraulic fluids, in particular brake fluids for motor vehicles having improved corrosion protection, which contain from 0.005 to 0.5% by weight of one or more heterocyclic compounds of the formula I

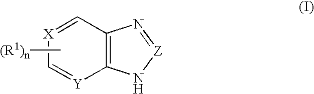

where

(i) X is N, Y is CR and Z is N or

(ii) X is N, Y is N and Z is N or CR or

(iii) X is CR, Y is N and Z is N,

R, in each case independently of further radicals R present, being hydrogen or a radical R¹,

R¹, in each case independently of further radicals R¹ present, being alkyl, aryl, aralkyl, halogen, haloalkyl, unsubstituted or alkyl-, aryl- or aralkyl-substituted amino, a heterocyclic radical, cyano, carboxyl, alkoxycarbonyl, hydroxyl or alkoxy, said organic radicals R¹ each having 1 to 30 carbon atoms, and

n being 0, 1 or 2.

Hydraulic fluids and in particular brake fluids for motor vehicles have to meet very high requirementes with respect to their chemical and physical properties. According to the existing standards and specifications for brake fluids from the US Department of Transportation in the Federal Motor Vehicle Safety Standard FMVSS No. 116 and the standard SAE J 1704 published by the Society of Automotive Engineers, modern brake fluids should, on the one hand, have high equilibrium reflux boiling points (ERBP) and high wet ERBPs but, on the other hand, also have a viscosity which changes only slightly within a wide temperature range.

The automotive industry furthermore requires improved corrosion protection of nonferrous metals, such as copper and its alloys.

However, the prior art hydraulic fluids and brake fluids for motor vehicles are still in need of improvement in this respect. It is an object of the present invention to provide hydraulic fluids which meet the abovementioned requirements for improved corrosion protection of nonferrous metals.

We have found that this object is achieved by the hydraulic or force-transmitting fluids defined at the outset.

Alkyl groups R¹ are preferably linear or branched C₁- to C₂₀-alkyl, in particular C₁- to C₈-alkyl, e.g. methyl, ethyl, n-propyl, isopropyl, n-butyl, sec-butyl, isobutyl, tert-butyl, n-pentyl, sec-pentyl, isopentyl, neopentyl, n-hexyl, n-heptyl, n-octyl, 2-ethylhexyl, n-nonyl, isononyl, n-decyl, isodecyl, n-undecyl, n-dodecyl, n-tridecyl, isotridecyl, n-tetradecyl, n-hexadecyl, n-octadecyl or eicosyl. In this context, R¹ may also be C₅- to C₈-cycloalkyl, such as cyclopentyl or cyclohexyl. Furthermore, R¹ may also be unsaturated C₃- to C₂₀-alkyl, i.e. C₃-to C₂₀-alkenyl, e.g. allyl, oleyl, linolyl or linolenyl.

Aryl groups R¹ are preferably C₆- to C₂₀-aryl which may be substituted by C₁- to C₄-alkyl, e.g. phenyl, naphthyl, o-, m- or p-tolyl, o-, m- or p-ethylphenyl or xylyl.

Aralkyl groups R¹ are preferably of 7 to 20 carbon atoms. Here, these are in particular corresponding alkyl radicals which carry a phenyl substituent which may itself be alkyl-substituted. Examples of these are benzyl, 2-phenylethyl, 3-phenylpropyl, 4-phenylbutyl, o-, m- and p-methylbenzyl or o-, m- and p-ethylbenzyl.

Halogen atoms R¹ are in particular fluorine, chlorine, bromine and iodine.

Haloalkyl groups R¹ are preferably mono-, di- or trihaloalkyl of 1 to 20, in particular 1 to 8, carbon atoms. Mono-, di- and trihalomethyl, such as fluoromethyl, chloromethyl, bromomethyl, difluoromethyl, dichloromethyl, dibromomethyl, fluorochloromethyl, chlorobromomethyl, fluorobromomethyl, trifluoromethyl, trichloromethyl, tribromomethyl, fluorodichloromethyl, difluorochloromethyl, chlorodibromomethyl, dichlorobromomethyl, difluorobromomethyl and fluorochlorobromomethyl, are particularly preferred here.

Unsubstituted or alkyl-, aryl- or aralkyl-substituted amino R¹ are in particular —NH₂, —NHR² and —N(R²)₂, where R², independently of one another, have the meanings listed above for alkyl, aryl or aralkyl in the case of R¹. Examples of these in addition to unsubstituted amino are methylamino, dimethylamino, ethylamino, diethylamino, butylamino, dibutylamino, phenylamino and benzylamino.

Heterocyclic radicals R¹ are preferably those organic radicals of up to 30 carbon atoms which contain at least one five-, six- or seven-membered ring system having one to three heteroatoms from the group consisting of oxygen, nitrogen and sulfur. Such heterocyclic radicals may furthermore contain aliphatic and/or isocyclic and/or aromatic structural elements and/or further heteroatoms. Examples of these are furanyl, thiophenyl, pyrrolidinyl, pyrrolinyl, pyrrolyl, oxazolyl, thiazolyl, pyrazolyl, imidazolyl, triazolyl, pyranyl, piperidinyl, morpholinyl, pyridyl, pyridazinyl, pyrimidinyl, pyrazinyl, triazinyl, indolinyl, indolyl, benzimidazolyl, benzotriazolyl, furfuryl (2-furanylmethyl), furfurylamino and histamino [2-(4-imidazolyl)ethylamino].

Alkyl radicals in the alkoxycarbonyl radicals R¹ are preferably the same radicals as those described above for R¹ itself, but in particular alkoxycarbonyl is C₁- to C₄-alkoxycarbonyl, such as methoxycarbonyl, ethoxycarbonyl or n-butoxycarbonyl.

Alkyl radicals in the alkoxy radical R¹ are preferably the same radicals as those described above for R¹, e.g. methoxy, ethoxy, n-propoxy, isopropoxy, n-butoxy, sec-butoxy, isobutoxy, tert-butoxy, n-pentyloxy, sec-pentyloxy, isopentyloxy, neopentyloxy, n-hexyloxy, n-heptyloxy, n-octyloxy, 2-ethylhexyloxy, n-nonyloxy, isononyloxy, n-decyloxy, isodecyloxy, n-undecyloxy, n-dodecyloxy, n-tridecyloxy, isotridecyloxy, n-tetradecyloxy, n-hexadecyloxy, n-octadecyloxy or eicosoxyl.

The heterocyclic derivatives of the formula I are compounds having four or five nitrogen atoms in the parent structure, especially triazolopyridines [cases (i) and (iii)] and purines [case (ii) where Z is CR].

If the six-membered ring moiety in such purines carries a substituent R¹ (n=1), this is preferably in the 6-position.

Particularly preferred individual compounds are:

unsubstituted purine (n=0)

adenine (=6-aminopurine)

6-chloropurine

2,6-dichloropurine

6-methoxypurine

1,2,3-triazolo[4,5B]pyridine

6-histaminopurine

6-furfurylaminopurine

The heterocyclic compounds of the formula I are known substances which are commercially available or can be synthesized by conventional preparation methods.

WO 95/10588 describes purine derivatives as additives for preventing the tarnishing of silver in detergent and cleaning agent formulations having a bleaching action, in particular dishwashing agents.

WO 96/20295 discloses the use of heterocyclic compounds of the type of the formula I as aqueous preflux coatings for the corrosion protection of copper and copper alloys in the manufacture of printed circuitboards.

A preferred embodiment of the present invention comprises brake fluids for motor vehicles which contain from 0.005 to 0.5% by weight of one or more of the heterocyclic compounds I described. Both for hydraulic fluids and for brake fluids for motor vehicles, preferred contents of the compounds I are from 0.005 to 0.10, in particular from 0.005 to 0.06, % by weight, based in each case on the total mass of the hydraulic fluid or brake fluid.

The presence of the heterocyclic compounds I ensures, in an excellent manner, that the hydraulic fluid or brake fluid for motor vehicles meets the requirements stated at the outset and that in particular corrosion protection for nonferrous metals, such as copper and its alloys, which is substantially improved compared with the prior art is achieved.

Further advantages of the novel hydraulic fluids and brake fluids for motor vehicles are their advantageous low-temperature viscosity, a generally good corrosion behavior, good water tolerance, a gentle pH, good low-temperature, high-temperature and oxidation stability and good chemical stability, advantageous behavior with respect to elastomers and rubber and good lubricating behavior.

In a preferred embodiment, the novel brake fluids for motor vehicles furthermore contain from 0.1 to 97, in particular from 30 to 97, especially from 50 to 97, % by weight, based in each case on the total mass of the brake fluid, of one or more polyglycol ethers and/or their boric acid esters, in addition to the heterocyclic compounds I.

Suitable polyglycol ethers here are in particular ethylene glycol monoalkyl ethers having up to 6 ethylene oxide units and up to 4 carbon atoms in the alkyl radical. Ethylene glycol dialkyl ether or propylene glycol dialkyl ether, each having up to 6 alkylene oxide units and each having up to 4 carbon atoms in the alkyl radicals, are also suitable.

Suitable boric acid esters of the stated or of other polyglycol ethers are described in particular in EP-B 013 925 (cyclic bis-boric acid esters), DE-C 28 04 535 (nitrogen-containing boric acid esters), DE-A 24 38 038 (esters of boric acid with alkylene glycol monoalkyl ethers) and DE-B 17 68 933 (tris-alkoxyalkyl esters of boric acid).

Instead of said polyglycol ethers and/or their boric acid esters the novel brake fluids for motor vehicles may contain, as main components, also those based on carboxylic esters, mineral oils or silicone oils.

In a further preferred embodiment, the novel brake fluids for motor vehicles furthermore contain from 0.1 to 50, in particular from 1 to 40, especially from 5 to 30, % by weight, based in each case on the total mass of the brake fluid, of one or more polyglycols, in addition to the heterocyclic compounds I.

Suitable polyglycols here are in particular relatively high-boiling reaction products of ethylene oxide and/or propylene oxide and/or butylene oxide with water or diols, in particular corresponding reaction products of mixtures of ethylene oxide and propylene oxide with water being used. The number of alkylene oxide units in such polyglycols is usually from 2 to 10.

The action of these high-boiling polyglycols is that of a lubricant, which is essentially due to an improvement in the temperature-viscosity behavior. The polyglycols impart sufficient viscosity to the low-viscosity polyglycol ethers at high temperatures and thus ensure sufficient lubrication. Sufficient lubrication is necessary in the components of the motor vehicle brake system because their rubber or elastomers must slide against metal as far as possible without wear.

In a further preferred embodiment, the novel brake fluids for motor vehicles furthermore contain from 0.005 to 10, in particular from 0.02 to 6, especially from 0.05 to 4, % by weight, based in each case on the total mass of the brake fluid, of one or more further additional corrosion inhibitors, in addition to the heterocyclic compounds I.

In brake fluids, corrosion inhibitors perform the function of preventing the destruction of metallic materials caused by corrosion. Suitable additional corrosion inhibitors here are in particular alkali metal salts of phosphoric acid and phosphorous acid, fatty acids, such as caprylic acid, lauric acid, palmitic acid, stearic acid or oleic acid, and their alkali metal salts, esters of phosphoric acid and of phosphorous acid, such as ethyl phosphate, dimethyl phosphate, isopropyl phosphate, diisopropyl phosphate, butyl phosphite or dimethyl phosphite, mono- and dialkylamines which may be ethoxylated and their salts with mineral and fatty acids, e.g. butylamine, hexylamine, octylamine, isononylamine, oleylamine, dipropylamine, diisopropylamine or dibutylamine, alkanolamines which may be ethoxylated, e.g. mono-, di- or triethanolamine, N,N′-di-n-butylaminoethanol or 1,1′-iminodipropan-2-ol, cyclohexylamine, benzimidazole, triazoles, such as benzotriazole or tolutriazole, and hydrogenated tolutriazole and nitroaromatics, e.g. 3-nitrobenzaldehyde.

In a particularly preferred embodiment, the novel brake fluids for motor vehicles contain from 0.005 to 0.5% by weight of benzimidazole, tolutriazole, benzotriazole and/or hydrogenated tolutriazole as additional corrosion inhibitors in addition to the heterocyclic compounds I.

Further components and assistants in the novel brake fluids for motor vehicles may be conventional antioxidants, such as phenothiazine and/or those based on phenol, e.g. bisphenol A, and conventional antifoams.

The novel brake fluids may also contain the cyclic carboxylic acid derivatives which are mentioned in German patent application 199 18 199.3 and are suitable as components for reducing the low-temperature viscosity in the presence of water.

### USE EXAMPLES

The novel brake fluids BF 2, BF 3, BF 4, BF 5, BF 6, BF 7, BF 8 and BF 9 were tested in comparison with a commercial DOT 5.1 brake fluid BF 1 (ERBP: 263° C., wet ERBP: 181° C., kinematic viscosity at −40° C.: 850 cSt) containing 0.05% by weight of tolutriazole as a corrosion inhibitor for nonferrous metals.

The motor vehicle brake fluids used had the following compositions:

66.95 or 66.99% by weight of methyltriglycol borate,

30% by weight of a mixture of methyldiglycol, methyltriglycol, methyltetraglycol and diglycol,

3% by weight of a mixture of 1,1′-iminodipropan-2-ol, 3-nitrobenzaldehyde and bisphenol A in a conventional mixing ratio,

BF 1: 0.05% by weight of tolutriazole or

BF 2: 0.05% by weight of adenine or

BF 3: 0.05% by weight of purine or

BF 4: 0.05% by weight of 6-methoxypurine or

BF 5: 0.05% by weight of 1H-1,2,3-triazolo[4,5B]pyridine or

BF 6: 0.01% by weight of adenine or

BF 7: 0.01% by weight of purine or

BF 8: 0.01% by weight of 6-methoxypurine or

BF 9: 0.01% by weight of 1H-1,2,3-triazolo[4,5B]pyridin

The performance tests were carried out according to the copper corrosion test D53 5387 in the version of January 1996 from PSA Peugeot-Citroen. Here, 500 ml of brake fluid are heated with 25 g of copper turnings for 100 hours at 120° C.; 10 liters of air per hour are passed first through distilled water at 2° C. and then through the liquid; the copper content of the liquid is then determined.

The results of the test described are shown in the table below:

TABLE

| | Cu content | Cu turnings, | |
|---|---|---|---|
| | [mg/kg] | appearance | pH |
| BF 1: | 75 | pronounced coating | 7.0 |
| BF 2: | 44 | bright, no coating | 8.0 |
| BE 3: | 15 | bright, no coating | 7.4 |
| BF 4: | 17 | bright, no coating | 7.7 |
| BF 5: | 5 | bright, no coating | 7.7 |
| BF 6: | 20 | bright, no coating | 7.6 |
| BF 7: | 18 | bright, no coating | 7.3 |
| BE 8: | 21 | bright, no coating | 7.4 |
| BE 9: | 13 | bright, no coating | 7.4 |

It is clear that, in contrast to conventional brake fluids such as BF 1, the novel formulations result in substantially better copper corrosion protection with coating-free metal surface.

We claim:

1. A hydraulic fluid having improved corrosion protection for nonferrous metals, containing from 0.005 to 0.5% by weight of one or more heterocyclic compounds of the formula I 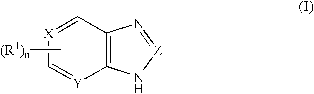
where
(i) X is N, Y is CR and Z is N or
(ii) X is N, Y is N and Z is N or CR or
(iii) X is CR, Y is N and Z is N,
R, in each case independently of further radicals R present, being hydrogen or a radical R¹,
R¹, in each case independently of further radicals R¹ present, being alkyl, aryl, aralkyl, halogen, haloalkyl, unsubstituted or alkyl-, aryl- or aralkyl-substituted amino, a heterocyclic radical, cyano, carboxyl, alkoxycarbonyl, hydroxyl or alkoxy, said organic radicals R¹ each having 1 to 30 carbon atoms, and
n being 0, 1 or 2.

2. A hydraulic fluid as claimed in claim 1, containing, as heterocyclic compounds I, purine, 6-aminopurine, 6-chloropurine, 2,6-dichloropurine, 6-methoxypurine, 1H-1,2,3-triazolo[4,5B]pyridine, 6-histaminopurine or 6-furfurylaminopurine.

3. A brake fluid for motor vehicles, containing from 0.005 to 0.5% by weight of one or more heterocyclic compounds I as claimed in claim 1 or 2.

4. A brake fluid for motor vehicles as claimed in claim 3, containing, in addition to the heterocyclic compounds I, furthermore from 0.1 to 95% by weight of one or more polyglycol ethers and/or their boric acid esters.

5. A brake fluid for motor vehicles as claimed in claim 3 or 4, containing, in addition to the heterocyclic compounds I, furthermore from 0.1 to 50% by weight of one or more polyglycols.

6. A brake fluid for motor vehicles as claimed in any of claims 3 to 5, containing, in addition to the heterocyclic compounds I, furthermore from 0.005 to 10% by weight of one or more additional corrosion inhibitors.

7. A brake fluid for motor vehicles as claimed in claim 6, containing, in addition to the heterocyclic compounds I from 0.005 to 0.5% by weight of benzimidazole, tolutriazole, benzotriazole and/or hydrogenated tolutriazole as additional corrosion inhibitors.
